(19) United States
(12) Patent Application Publication
(10) Pub. No.: US 2015/0280243 A1
(43) Pub. Date: Oct. 1, 2015

(54) MESH PLATE TYPE NICKEL SECONDARY BATTERY UNIT CELL AND NICKEL SECONDARY BATTERY STACK INCLUDING THE SAME

(71) Applicant: VITZROCELL CO. LTD., Chungcheongnam-do (KR)

(72) Inventors: Sang-Sun PARK, Chungcheongnam-do (KR); Tae-Woo CHO, Uiwang-si (KR); Bum-Soo KIM, Cheonan-si (KR)

(73) Assignee: VITZROCELL CO. LTD., Chungcheongnam-do (KR)

(21) Appl. No.: 14/260,567

(22) Filed: Apr. 24, 2014

(30) Foreign Application Priority Data
Mar. 27, 2014 (KR) 10-2014-0035813

(51) Int. Cl. H01M 4/80

(52) U.S. Cl. CPC H01M 4/80

(57) ABSTRACT

Disclosed are a mesh plate type nickel secondary battery unit cell and a nickel secondary battery stack including the same. The mesh plate type nickel secondary battery unit cell can secure a uniform gap between cathode and anode plates by withstanding expansion of a central portion of the cathode plate due to swelling caused by charge/discharge through a mesh plate structure of the cathode and anode plates and can prevent short circuit. The nickel secondary battery unit cell includes a cathode plate having a mesh plate structure; an anode plate having a mesh plate structure and separated from the cathode plate to face the cathode plate; and a separator interposed in a space between the cathode and anode plates.

### CROSS-REFERENCE TO RELATED APPLICATION

This application claims priority to Korean Patent Application No. 10-2014-0035813 filed on Mar. 27, 2014, and all the benefits accruing therefrom under 35 U.S.C. §119, the contents of which is incorporated by reference in its entirety.

### BACKGROUND

1. Technical Field

The present invention relates to a nickel secondary battery unit cell and a nickel secondary battery stack including the same. More particularly, the present invention relates to a mesh plate type nickel secondary battery unit cell, which can prevent short circuit and secure a uniform gap between cathode and anode plates by withstanding expansion of a central portion of the cathode plate due to swelling caused by charge/discharge through a mesh plate structure of the cathode and anode plates, and a nickel secondary battery stack including the same.

2. Description of the Related Art

Recently, various environmental regulations are enforced for the purpose of environmental preservation in various countries. Thus, although lead batteries and nickel/cadmium batteries have already been replaced by nickel/hydrogen batteries, lithium ion batteries, and the like in the field of small-size batteries, since there is no alternative battery capable of replacing the lead batteries and nickel/cadmium batteries in the field of large industrial batteries, the lead batteries and the nickel/cadmium batteries are still used for the large industrial batteries. Thus, interest in eco-friendly large capacity batteries is increasing, and techniques for producing such batteries are being intensively developed.

Among such batteries, a nickel (Ni)/zinc (Zn) secondary battery capable of replacing lead batteries has various advantages, such as similar volume energy density, a high operating voltage of 1.6 V/cell or more; a specific power density of 875 W/kg, which is higher than that of the lead batteries having a specific power density of 535 W/kg; and a relatively stable charge/discharge cycle life of 600 cycles or more, which means the number of charge/discharge cycles for reaching 80% of maximum discharging capacity, as compared with the lead batteries having a charge/discharge cycle life of 200 cycles to 700 cycles.

Generally, a secondary battery includes: a cathode plate; an anode plate disposed parallel to the cathode plate; a separator interposed in a space between the cathode and anode plates to prevent electrical contact therebetween, and has a structure in which the cathode and anode plates and the separator are dipped in a case receiving an electrolyte.

However, since a typical secondary battery includes the cathode and anode plates having a simple plate structure, there are problems in that the cathode plate expands due to swelling caused by long-term charge/discharge in a state in which a unit cell is dipped in the electrolyte of the case after the unit cell is fastened, thereby causing rapid deterioration in charge/discharge efficiency of the secondary battery due to non-uniform separation gap between the cathode and anode plates, and in that short circuit occurs between an outermost edge of the cathode plate and the anode plate protruding from the separator due to swelling.

As a reference in the related art, Korean Patent Publication No. 10-2008-0114330A (publication date: Dec. 31, 2008) discloses an anode plate for nickel/zinc secondary batteries for increasing a reaction area and a method of preparing the same.

### BRIEF SUMMARY

It is an aspect of the present invention to provide a mesh plate type nickel secondary battery unit cell, which can secure a uniform gap between cathode and anode plates and prevent short circuit by withstanding expansion of a central portion of the cathode plate due to swelling caused by charge/discharge, and a nickel secondary battery stack including the mesh plate type nickel secondary battery unit cell.

In accordance with one aspect of the present invention, a mesh plate type nickel secondary battery unit cell includes: a cathode plate having a mesh plate structure; an anode plate having a mesh plate structure and separated from the cathode plate to face the cathode plate; and a separator interposed in a space between the cathode and anode plates.

In accordance with another aspect of the present invention, a mesh plate type nickel secondary battery stack includes: at least two secondary battery unit cells stacked one above another; first and second end plates mounted on both outermost sides of the stacked secondary battery unit cells, respectively; and a fastening member fastening the first and second end plates to the stacked secondary battery unit cells, wherein the secondary battery unit cell includes: a cathode plate having a mesh plate structure; an anode plate having a mesh plate structure and separated from the cathode plate to face the cathode plate; and a separator interposed in a space between the cathode and anode plates.

According to the present invention, in the mesh plate type nickel secondary battery unit cell and the nickel secondary battery stack including the same, since the cathode plate exhibiting relatively high stiffness has a rim stably attached to the separator by weight thereof, even when the unit cell, which is dipped in an electrolyte received in a case after the unit cell is fastened, is subjected to long-term charge/discharge, the mesh plate type nickel secondary battery unit cell and the nickel secondary battery stack including the same can withstand swelling since a central portion of the cathode plate has a mesh structure having a plurality of openings to provide relatively low stiffness.

According to the present invention, the mesh plate type nickel secondary battery unit cell and the nickel secondary battery stack including the same can secure a uniform separation gap between the cathode and anode plates, thereby improving charge/discharge efficiency while preventing short-circuit of the cathode and anode plates thereof.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is an exploded perspective view of a nickel secondary battery unit cell according to one embodiment of the present invention;

FIG. 2 is an enlarged plan view of a cathode plate having a mesh plate structure of FIG. 1;

FIG. 3 is a plan view of a modification of the cathode plate having a mesh plate structure; and

FIG. 4 is a perspective view of a nickel secondary battery stack according to one embodiment of the present invention.

### DETAILED DESCRIPTION

Hereinafter, embodiments of the present invention will be described in detail with reference to the accompanying drawings. It should be understood that the present invention is not limited to the following embodiments and may be embodied in different ways, and that the embodiments are provided for complete disclosure and thorough understanding of the invention by those skilled in the art. Therefore, the scope and sprit of the present invention should be defined only by the accompanying claims and equivalents thereof. Like components will be denoted by like reference numerals throughout the specification.

A mesh plate type nickel secondary battery unit cell and a nickel secondary battery stack including the mesh plate type nickel secondary battery unit cell according to embodiments of the present invention will be described in detail with reference to the accompanying drawings.

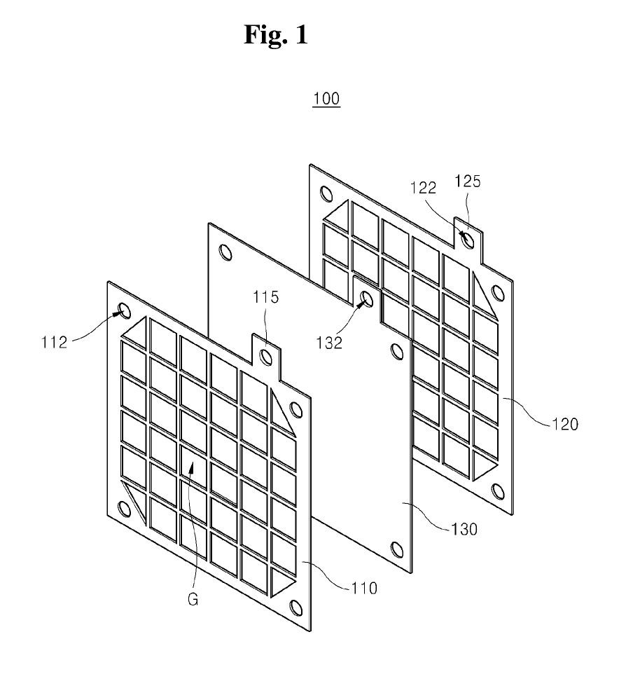

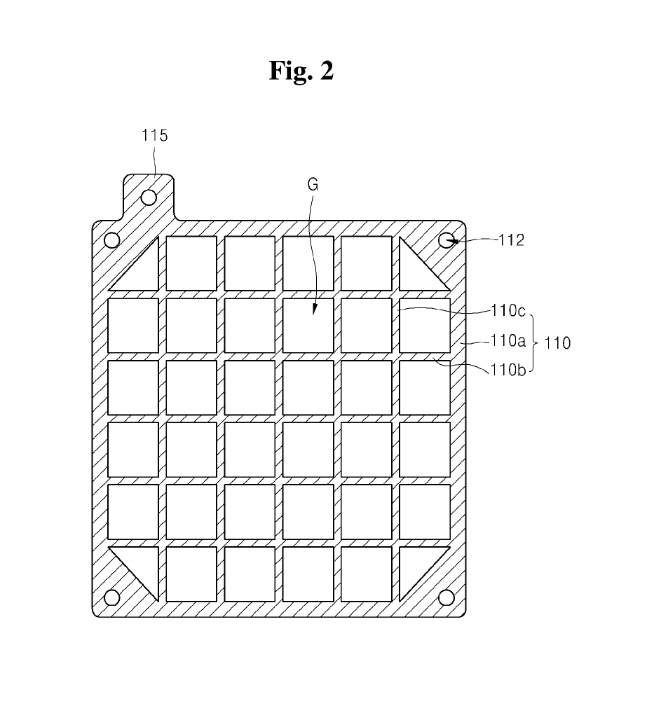

FIG. 1 is an exploded perspective view of a nickel secondary battery unit cell according to one embodiment of the present invention, and FIG. 2 is an enlarged plan view of a cathode plate having a mesh plate structure of FIG. 1.

Referring to FIGS. 1 and 2, a nickel secondary battery unit cell 100 according one embodiment includes a cathode plate 110, an anode plate 120, and a separator 130.

The cathode plate 110 has a mesh plate structure. The cathode plate 110 includes a cathode terminal 115 for charge/discharge of a secondary battery. Here, the cathode plate 110 may have a structure in which a cathode active material is coated onto one or both surfaces of a nickel (Ni)-containing current collector having a mesh plate shape. The cathode active material may include nickel hydroxide (Ni(OH)₂) and additives added to the nickel hydroxide, and may further include a binder and a thickener in addition to the additives.

The cathode plate 110 may include a cathode plate body 110a having a quadrangular rim shape having an open inner side thereof; a plurality of first extending lines 110b, which extend from the cathode plate body 110a and are arranged at intervals in a first direction; a plurality of second extending lines 110c arranged at intervals in a second direction intersecting the first direction; and a plurality of openings G defined by the first and second extending lines 110b and 110c.

As such, according to the present invention, the cathode plate 110 has a mesh plate structure including the plural openings G defined by the first and second extending lines 110b and 110c. In addition, since the rim at which the cathode plate body 110a is disposed exhibits higher stiffness than a central portion in which the first and second extending lines 110b and 110c and the plural openings G are formed, the rim of the cathode plate 110 can be stably attached to the separator 130 by weight thereof. Here, the plural openings may have a rectangular shape, without being limited thereto.

Each of the first and second extending lines 110b and 110c may have a width from 1.0 mm to 3.0 mm. If the width of each of the first and second extending lines 110b and 110c is less than 1.0 mm, the first and second extending lines 110b and 110c can have a narrow linewidth to secure stiffness, thereby providing insufficient resistance to swelling. Conversely, if the width of each of the first and second extending lines 110b and 110c is greater than 3.0 mm, there is a possibility of reducing a reaction area due to excessive width of the first and second extending lines 110b and 110c.

The plural openings G may have an area of 70% or less of the total area of the cathode plate 110. If the area of the plural openings G is greater than 70% of the total area of the cathode plate 110, an area of an electrode can be reduced due to excessive area of the openings G, thereby causing deterioration in charge/discharge efficiency.

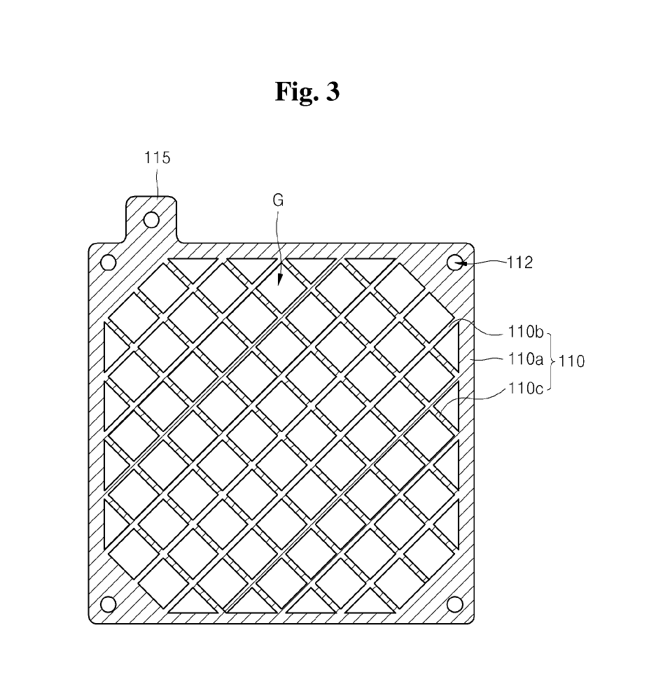

FIG. 3 is a plan view of a modification of the cathode plate having a mesh plate structure.

As shown in FIG. 3, the first extending lines 110b may be diagonally arranged in the first direction, and the second extending lines 110c may be diagonally arranged in the second direction intersecting the first direction. Thus, plural openings G, which are arranged in the central portion of the cathode plate body 110a, may have a diamond shape, and plural openings G, which are arranged along an outermost edge of the cathode plate body 110a, may have a triangular shape.

Referring to FIGS. 1 and 2 again, the anode plate 120 has a mesh plate structure like the cathode plate 110, and in this case, the anode plate 120 may have substantially the same structure as that of the cathode plate 110. Thus, the anode plate 120 may include: an anode plate body (not shown) having a quadrangular rim shape having an open inner side thereof; a plurality of first extending lines (not shown), which extend from the anode plate body and are arranged at intervals in a first direction; a plurality of second extending lines (not shown) arranged at intervals in a second direction intersecting the first direction; and a plurality of openings G defined by the first and second extending lines. Otherwise, the anode plate 120 may also have a plate structure.

The anode plate 120 includes an anode terminal 125 for charge/discharge of the secondary battery. Here, the anode plate 120 may have a structure in which an anode active material is coated onto one or both surfaces of a nickel-containing current collector having a network structure. The anode active material may include zinc oxide and additives added to the zinc oxide, and may further include a binder and a thickener in addition to the additives.

Alternatively, the anode active material may be metal hydride (MH) alloys, cadmium oxide, and the like. Thus, according to embodiments of the invention, the mesh plate type nickel secondary unit cell may be any one of Ni—Zn, Ni—MH, and Ni—Cd secondary batteries.

Since a typical secondary battery includes cathode and anode plates having a simple plate structure, there are problems in that charge/discharge efficiency is rapidly decreased due to non-uniform separation gap between the cathode and anode plates since the cathode plate expands due to swelling caused by long-term charge/discharge of the secondary battery unit cell dipped in an electrolyte of a case after the unit cell is fastened, and in that short-circuit of an outermost edge of the cathode plate and the anode plate protruding from the separator occurs due to swelling.

Unlike the typical secondary battery, in the mesh plate type secondary battery unit cell 100 according to the embodiment of the invention, since each of the cathode and anode plates 110, 120 has a mesh plate structure, the rim of the cathode plate 110 exhibits higher stiffness than the central portion thereof. Thus, even when the unit cell 100, which is dipped in the electrolyte of the case after the unit cell 100 is fastened, is subjected to long-term charge/discharge, the mesh plate type secondary battery unit cell can withstand swelling of the cathode plate 110.

As a result, in the mesh plate type secondary battery unit cell 100 according to the embodiment of the invention, the rim of the cathode plate 110 exhibiting relatively high stiffness is stably attached to the separator 130 by weight thereof. Thus, even when the unit cell 100, which is dipped in the electrolyte of the case after the unit cell 100 is fastened, is subjected to long-term charge/discharge, the mesh plate type secondary battery unit cell can withstand swelling of the central portion of the cathode plate 110 since the central portion of the cathode plate 110 has relatively low stiffness due to the structure including the plural openings G. As a result, the secondary battery unit cell can secure a uniform separation gap between the cathode and anode plates 110, 120, thereby improving charge/discharge efficiency while preventing short circuit of the cathode and anode plates 110, 120.

The separator 130 is interposed in a space between the cathode and anode plates 110, 120 and serves to electrically insulate the cathode plate 110 from the anode plate 120. Here, the separator 130 may be any one selected from among non-woven polyethylene fabrics, non-woven polypropylene fabrics, non-woven polyester fabrics, porous polyacrylonitrile separators, poly(vinylidene fluoride) hexafluoropropane copolymer porous separators, porous cellulose separators, Kraft paper, and the like.

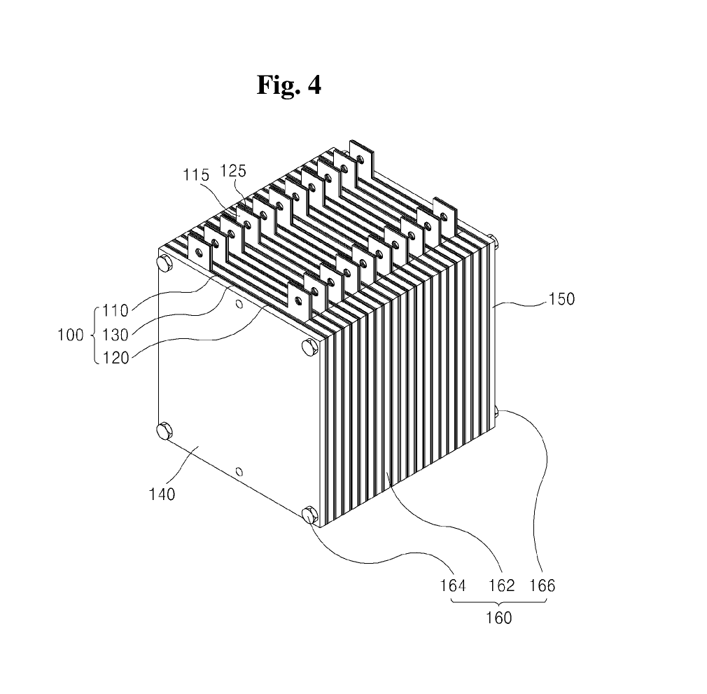

Here, the cathode plate 110, the anode plate 120, and the separator 130 include first, second and third through-holes 112, 122, 132 formed at outermost edges thereof, respectively. The first, second and third through-holes 112, 122, 132 are formed for the purpose of fastening the unit cells 100 using a fastening member 160 (see FIG. 4) when the unit cells 100 are assembled, and may be formed at four corners for stable fastening. Advantageously, the first, second and third through-holes 112, 122, 132 may be formed at the same positions in the cathode plate 110, the anode plate 120, and the separator 130, respectively.

In the mesh plate type secondary battery unit cell according to the embodiment of the invention, the rim of the cathode plate exhibiting relatively high stiffness is stably attached to the separator by weight thereof. Thus, even when the unit cell 100, which is dipped in the electrolyte of the case after the unit cell 100 is fastened, is subjected to long-term charge/discharge, the mesh plate type secondary battery unit cell can withstand swelling of the central portion of the cathode plate, since the central portion of the cathode plate has relatively low stiffness due to the structure including the plural openings G.

As a result, the mesh plate type secondary battery unit cell can secure a uniform separation gap between the cathode and anode plates, thereby improving charge/discharge efficiency while preventing short circuit of the cathode and anode plates.

FIG. 4 is a perspective view of a nickel secondary battery stack according to one embodiment of the present invention and will be described in conjunction with FIG. 1.

Referring to FIGS. 1 and 4, a nickel secondary battery stack 200 includes secondary battery unit cells 100, first and second end plates 140, 150, and fastening members 160.

At least two secondary battery unit cells 100 are stacked. Each of the secondary battery unit cells 100 includes a cathode plate 110 having a mesh plate structure; an anode plate 120 having a mesh plate structure and separated from the cathode plate 110 to face the cathode plate 110; and a separator 130 interposed in a space between the cathode and anode plates 110, 120. In addition, the secondary battery unit cell 100 includes: cathode terminals 115 included in the cathode plate 110; and anode terminals 125 included in the anode plate 120. Here, a plurality of cathode or anode terminals 115 or 125 may be alternately disposed in a zigzag arrangement. The number of stacked secondary battery unit cells 100 may be modified in various ways.

The first and second end plates 140, 150 are mounted on both outermost sides of the stacked secondary battery unit cells 100, respectively. The first and second end plates 140, 150 may have substantially the same plate structure as the anode plate 120. The first and second end plates 140, 150 include fourth and fifth through-holes (not shown) at outermost edges thereof, respectively. The fourth and fifth through-holes are formed for the purpose of fastening the first and second end plates 140, 150 to the stacked secondary battery unit cells 100 using the fastening member 160, and may be formed at four corners of the first and second end plates 140, 150 corresponding to the first, second and third through-holes 112, 122, 132 for stable fastening, respectively.

The fastening member 160 serves to fasten the first and second end plates 140, 150 to the stacked secondary battery unit cells 100. Here, the fastening member 160 may include an isolation support 162 interposed in a space between the stacked secondary battery unit cells 100 and electrically isolating the stacked secondary battery unit cells 100 from each other; a fastening bolt 164 which passes through the through-holes of the first end plate 140, the stacked secondary battery unit cells 100 and the isolation support 162 and then is finally inserted into the through-holes of the second end plate 150; and a fastening nut 166 mounted on an outside of the second end plate 150 to secure the fastening bolt 164.

According to the embodiment of the invention, since the mesh plate type nickel secondary battery stack includes plural cathode and anode plates each having a mesh plate structure, the rim of the cathode plate exhibiting relatively high stiffness can be stably attached to the separator due to weight thereof. Thus, even when the unit cell, which is dipped in a case containing an electrolyte after the unit cell is fastened, is subjected to long-term charge/discharge, the mesh plate type nickel secondary battery stack can withstand swelling of the central portion of the cathode plate since the central portion of the cathode plate has relatively low stiffness due to a mesh structure including the plural openings.

Therefore, in the mesh plate type nickel secondary battery stack according to the embodiment of the invention, since a uniform separation gap between the cathode and anode plates can be secured, the nickel secondary battery stack has improved charge/discharge efficiency and can prevent short-circuit of the cathode and anode plates.

Although some embodiments have been described herein, it should be understood that various modifications, changes, alterations, and equivalent embodiments can be made by those skilled in the art without departing from the spirit and scope of the invention. Therefore, the scope of the invention should be limited only by the accompanying claims and equivalents thereof.

What is claimed is:

1. A nickel secondary battery unit cell comprising:
a cathode plate having a mesh plate structure;
an anode plate having a mesh plate structure and separated from the cathode plate to face the cathode plate; and
a separator interposed in a space between the cathode and anode plates.

2. The nickel secondary battery unit cell according to claim 1, wherein the cathode plate has a structure in which a cathode active material is coated onto one or both surfaces of a nickel (Ni)-containing current collector having a mesh plate shape.

3. The nickel secondary battery unit cell according to claim 1, wherein the anode plate has a structure in which an anode active material is coated onto one or both surfaces of a nickel-containing current collector of a network structure.

4. The nickel secondary battery unit cell according to claim 1, wherein each of the cathode and anode plates comprises:
a plate body having a quadrangular rim shape;
a plurality of first extending lines extending from the plate body and arranged at intervals in a first direction;
a plurality of second extending lines arranged at intervals in a second direction intersecting the first direction; and
a plurality of openings defined by the first and second extending lines.

5. The nickel secondary battery unit cell according to claim 4, wherein the plural openings have at least one of rectangular, diamond and triangular shapes.

6. The nickel secondary battery unit cell according to claim 4, wherein the plural openings have an area of 70% or less of a total area of the cathode and anode plates.

7. The nickel secondary battery unit cell according to claim 4, wherein each of the first and second extending lines has a width from 1.0 mm to 3.0 mm.

8. The nickel secondary battery unit cell according to claim 1, wherein the cathode and anode plates, and the separator comprise first, second and third through-holes at outermost edges thereof, respectively.

9. A nickel secondary battery stack, comprising:
at least two secondary battery unit cells stacked one above another;
first and second end plates mounted on both outermost sides of the secondary battery unit cells, respectively; and
a fastening member fastening the first and second end plates to the stacked secondary battery unit cells,
wherein each of the secondary battery unit cells comprises: a cathode plate having a mesh plate structure; an anode plate having a mesh plate structure and separated from the cathode plate to face the cathode plate; and a separator interposed in a space between the cathode and anode plates.

10. The nickel secondary battery stack according to claim 9, wherein the fastening member comprises:
an isolation support interposed in a space between the stacked secondary battery unit cells and electrically isolating the stacked secondary battery unit cells from each other;
a fastening bolt passing through through-holes of the first end plate, the stacked secondary battery unit cells and the isolation support from the first end plate and finally inserted into a through-hole of the second end plate; and
a fastening nut mounted on an outside of the second end plate to secure the fastening bolt.

11. The nickel secondary battery stack according to claim 9, wherein the secondary battery unit cell comprises:
cathode terminals provided to the cathode plate; and
anode terminals provided to the anode plate,
the cathode or anode terminals being alternately disposed in a zigzag arrangement.
